(19) United States
(12) Patent Application Publication
(10) Pub. No.: US 2010/0216048 A1
(43) Pub. Date: Aug. 26, 2010

(54) METHOD FOR THE PRODUCTION OF A MEMBRANE ELECTRODE UNIT

(75) Inventors: Sigmar Braeuninger, Hemsbach (DE); Gunter Bechtloff, Heuchelheim (DE); Werner Urban, Mannheim (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, Ludwigshafen (DE)

(21) Appl. No.: 12/444,019

(22) PCT Filed: Sep. 28, 2007
(86) PCT No.: PCT/EP07/60310

§ 371 Date: Apr. 2, 2009

(30) Foreign Application Priority Data
Oct. 2, 2006 (EP) 06121604.0

(51) Int. Cl. H01M 8/10; H01M 4/88

(52) U.S. Cl. 429/483; 427/558

(57) ABSTRACT

The invention relates to a process for producing a membrane-electrode assembly comprising an anode catalyst layer (13), a polymer electrolyte membrane (1) and a cathode catalyst layer (14) and to a fuel cell comprising such a membrane-electrode assembly. The process of the invention comprises the steps of applying a first border (17) comprising a UV-curable material to the polymer electrolyte membrane (1), with an inner region (16) of the polymer electrolyte membrane (1) remaining free of the UV-curable material, applying a catalyst layer (2) which covers the inner region (16) of the polymer electrolyte membrane (1) and overlaps the first border (17), applying a second border (18) comprising the UV-curable material to the first border (17), with the second border (18) surrounding the catalyst layer (2), applying a third border (19) comprising the UV-curable material to the second border (18), with the third border (19) overlapping the catalyst layer (2), and irradiating the first, second and third borders (17, 18, 19) with UV radiation.

The invention relates to a process for producing a membrane-electrode assembly comprising an anode catalyst layer, a polymer electrolyte membrane and a cathode catalyst layer and to a fuel cell comprising such a membrane-electrode assembly.

Fuel cells are energy transformers which convert chemical energy into electric energy. In a fuel cell, the principle of electrolysis is reversed. Here, a fuel (for example hydrogen) and an oxidant (for example oxygen) are converted in physically separate places at two electrodes into electric power, water and heat. Various types of fuel cells which generally differ from one another in terms of the operating temperature are known today. However, the structure of the cells is in principle the same in all types. They generally comprise two electrodes, viz. an anode and a cathode, at which the reactions proceed and an electrolyte between the two electrodes. In the case of a polymer electrolyte membrane fuel cell (PEM fuel cell), a polymer membrane which conducts ions (in particular H⁺ ions) is used as electrolyte. The electrolyte has three functions. It establishes ionic contact, prevents electronic contact and also ensures that the gases supplied to the electrodes are kept apart from one another. The electrodes are generally supplied with gases which are reacted in a redox reaction. The electrodes have the task of feeding in the gases (for example hydrogen or methanol and oxygen or air), discharging reaction products such as water or CO₂, catalytically reacting the starting materials and supplying or conducting away electrons. The conversion of chemical energy into electric energy takes place at the three-phase boundary of catalytically active sites (for example platinum), ion conductors (for example ion-exchange polymers), electronic conductors (for example graphite) and gases (for example H₂ and O₂). It is important for the catalysts to have a very large active area.

The key part of a PEM fuel cell is a polymer electrolyte membrane which has been coated with catalyst on both sides (CCM=catalyst coated membrane) or a membrane-electrode assembly (MEA). A catalyst coated membrane (CCM) is in this context a three-layer polymer electrolyte membrane which is coated with catalyst on both sides and comprises an outer anode catalyst layer on one side of a membrane layer, the central membrane layer and an outer cathode catalyst layer on the side of the membrane layer opposite the anode catalyst layer. The membrane layer comprises proton-conducting polymer materials which will hereinafter be referred to as ionomers. The catalyst layers comprise catalytically active components which catalyze the respective reaction at the anode or cathode (for example oxidation of hydrogen, reduction of oxygen). As catalytically active components, preference is given to using the metals of the platinum group of the Periodic Table of the Elements.

The membrane-electrode assembly comprises a polymer electrolyte membrane coated with catalyst on both sides and at least one gas diffusion layer (GDL). The gas diffusion layers serve to supply gas to the catalyst layers and to conduct away the cell current.

Membrane-electrode assemblies are known it the prior art, for example from WO 2005/006473 A2. The membrane-electrode assembly described there comprises an ion-conducting membrane having a front side and a rear side, a first catalyst layer and a first gas diffusion layer on the front side and a second catalyst layer and a second gas diffusion layer on the rear side, with the first gas diffusion layer having smaller planar dimensions than the ion-conducting membrane and the second gas diffusion layer having essentially the same planar dimensions as the ion-conducting membrane.

WO 00/10216 A1 relates to a membrane-electrode assembly comprising a polymer electrolyte membrane which has a central region and a peripheral region. An electrode is located above the central region and part of the peripheral region of the polymer electrolyte membrane. A lower seal is arranged on the peripheral region of the polymer electrolyte membrane so that it also extends over the part of the electrode which extends into the peripheral region of the polymer electrolyte membrane and a further seal is arranged at least partly on the lower seal.

WO 2006/041677 A1 relates to a membrane-electrode assembly having a structural unit comprising a polymer electrolyte membrane, a gas diffusion layer and a catalyst layer between the polymer electrolyte membrane and the gas diffusion layer. A sealing element is arranged above one or more constituent parts of the structural unit, with an outer margin of the gas diffusion layer overlapping the sealing element. The sealing element comprises a layer of a material which can be deposited and cured in situ.

A person skilled in the art will know many methods of producing membrane-electrode assemblies. For example, U.S. Pat. No. 6,500,217 B1 describes a process for applying electrode layers to a continuous strip of polymer electrolyte membrane. Here, the front and rear sides of the membrane are continuously printed in the desired pattern with the electrode layers using an ink comprising an electrocatalyst and the printed-on electrode layers are dried at elevated temperature immediately after printing, wherein printing is carried out with maintenance of a positionally accurate arrangement of the patterns of the electrode layers of front and rear sides.

In a fuel cell, the membrane-electrode assembly is typically inserted between two gas distributor plates. The gas distributor plates serve to conduct away the current and act as distributors for reaction fluid streams (for example hydrogen, oxygen or a liquid fuel, for example formic acid). To achieve distribution of the reaction fluid streams to the electrochemically inactive region of the membrane-electrode assembly, the surfaces of the gas distributor plates facing the membrane-electrode assembly are usually provided with channels or depressions having an open side.

In a fuel cell stack, a plurality of individual fuel cells are connected in series in order to increase the total power output. In such a stack, one side of a gas distributor plate acts as anode of a fuel cell and the other side of the gas distributor plate acts as cathode of an adjoining fuel cell. In such an arrangement, the gas distributor plates are, (apart from the end plates) referred to as bipolar plates.

To ensure that the reactants (fuel and oxidant) which are supplied to the membrane-electrode assembly do not mix, the two sides of the membrane-electrode assembly separated by the polymer electrolyte membrane have to be sealed from one another and the fuel cell has to be sealed from its environment. In conventional fuel cells, sealing frames, for example, which are arranged between the gas distributor plates and the membrane, if appropriate in combination with elastic seals, are provided for this purpose. Clamping together of the gas distributor plates and the membrane-electrode assembly should ensure fluid-tight sealing by the sealing frames (and, if appropriate, the elastic seals). The resulting compressive stress incurs the risk of deformation or even tearing of the polymer electrolyte membrane at the outer edge of the electrochemically active area (edge of the catalyst layers) and also at the inner edge of the sealing frame.

It is therefore an object of the present invention to avoid the disadvantages of the prior art and, in particular, make sealing and stabilization of the polymer electrolyte membrane of a membrane-electrode assembly possible, particularly in the region of the edge of the electrochemically active area.

This object is achieved according to the invention by a process for producing a membrane-electrode assembly comprising an anode catalyst layer, a polymer electrolyte membrane and a cathode catalyst layer. The process of the invention comprises the steps of applying a first border comprising a UV-curable material to the polymer electrolyte membrane, with an inner region of the polymer electrolyte membrane remaining free of the UV-curable material, applying a catalyst layer which covers the inner region of the polymer electrolyte membrane and overlaps the first border, applying a second border comprising the UV-curable material to the first border, with the second border surrounding the catalyst layer, applying a third border comprising the UV-curable material to the second border, with the third border overlapping the catalyst layer and irradiating the first, second and third borders with UV radiation. The second and third borders can be applied separately or together in one step to the first border. The finished membrane-electrode assembly therefore has a border comprising UV-cured material which is formed by the three largely superposed borders comprising UV-cured material.

The polymer electrolyte membrane preferably comprises cation-conducting polymer materials. Use is usually made of a tetrafluoroethylene-fluorovinyl ether copolymer having acid functions, in particular sulfonic acid groups. Such a material is marketed, for example, under the trade name Nafion® by E.I. DuPont. Examples of polymer electrolyte materials which can be used in the present invention are the following polymer materials and mixtures thereof:
Nafion® (DuPont; USA)
perfluorinated and/or partially fluorinated polymers such as “Dow Experimental Membrane” (Dow Chemicals, USA),
Aciplex-S® (Asahi Chemicals, Japan),
Raipore R-1010 (Pall Rai Manufacturing Co., USA),
Flemion (Asahi Glas, Japan),
Raymion® (Chlorine Engineering Corp., Japan).

However, other, in particular essentially fluorine-free, ionomer materials can also be used, for example sulfonated phenol-formaldehyde resins (linear or crosslinked); sulfonated polystyrene (linear or crosslinked); sulfonated poly-2,6-diphenyl-1,4-phenylene oxides, sulfonated polyaryl ether sulfones, sulfonated polyarylene ether sulfones, sulfonated polyaryl ether ketones, phosphonated poly-2,6-dimethyl-1,4-phenylene oxides, sulfonated polyether ketones, sulfonated polyether ether ketones, aryl ketones or polybenzimidazoles.

Further suitable polymer materials are ones which comprise the following constituents (or mixtures thereof): polybenzimidazole-phosphoric acid, sulfonated polyphenylenes, sulfonated polyphenylene sulfide and polymeric sulfonic acids of the polymer-SO₃X type (X=NH₄⁺, NH₃R⁺, NH₂R₂⁺, NHR₃⁺, NR₄⁺).

The polymer electrolyte membrane used for the present invention preferably has a thickness of from 20 to 100 μm, more preferably from 40 to 70 μm.

The anode and cathode catalyst layers of the membrane-electrode assembly comprise at least one catalytic component which, for example, catalyzes the reaction of oxidation of hydrogen or reduction of oxygen. The catalyst layers can also comprise a plurality of catalytic substances having various functions. In addition, the respective catalyst layer can comprise a functionalized polymer (ionomer) or an unfunctionalized polymer.

Furthermore, an electron conductor is preferably present in the catalyst layers for the purpose of, inter alia, conducting the electric current flowing in the fuel cell reaction and as support material for the catalytic substances.

The catalyst layers preferably comprise at least one element of groups 3 to 14 of the Periodic Table of the Elements (PTE), particularly preferably groups 8 to 14 of the PTE, as catalytic component. The cathode catalyst layer preferably comprises at least one element selected from the group consisting of the elements Pt, Co, Fe, Cr, Mn, Cu, V, Ru, Pd, Ni, Mo, Sn, Zn, Au, Ag, Rh, Ir and W as catalytic component. The anode catalyst layer preferably comprises at least one element selected from the group consisting of the elements Co, Fe, Cr, Mn, Cu, V, Ru, Pd, Ni, Mo, Sn, Zn, Au, Rh, Ir and W as catalytic component.

The process of the invention for producing a membrane-electrode assembly comprises applying a border comprising a UV-curable material to the polymer electrolyte membrane, with an inner region of the polymer electrolyte membrane remaining free of the UV-curable material. In this context, a UV-curable material is a material in the form of a liquid or paste which can be solidified by irradiation with UV radiation, in particular a material which can be polymerized by means of UV irradiation. In the prior art, UV-curable material is used, for example, for coating bipolar plates (U.S. Pat. No. 6,730,363 B1, WO 02/17421 A2, WO 02/17422 A2) for producing channels for fluids (WO 03/096455 A2), as sealing material on bipolar plates (EP 1 073 138 A2) or as spacer in a polymer electrolyte membrane of a fuel cell (US 2004/0209155 A1). The use of UV-curable material for the present invention has the advantage that it can be solidified without thermal stressing of the polymer electrolyte membrane. This advantage is not offered by, for example, a hot melt adhesive process.

In the present invention, the application of the border comprising the UV-curable material, in particular to the polymer electrolyte membrane, is effected, for example, by doctor blade, spraying, casting, pressure or extrusion methods.

The UV-curable material is preferably low in solvent or free of solvent. This has the advantage that contamination or swelling of the polymer electrolyte membrane by a solvent is avoided. Furthermore, there is no workplace pollution by solvents during processing of a solvent-free UV-curable material. However, solvent-comprising UV-curable materials can also be used for the present invention. The UV-curable material is preferably liquid at room temperature in order to make uncomplicated processing possible. It is advantageous to apply only one component as UV-curable material, so that prior mixing as in the case of, for example, a two-component adhesive is not necessary. The use of the UV-curable material has the further advantage that it ensures great flexibility in respect of the time of further processing (i.e. with regard to the point in time of irradiation with UV radiation).

The border surrounds the inner region in which no UV-curable material is applied to the polymer electrolyte membrane and which comprises an electrochemically active area in the finished membrane-electrode assembly.

According to the invention, the border comprising UV-curable material on the polymer electrolyte membrane is irradiated with UV radiation so that the material cures and a border comprising UV-curable material is formed on the polymer electrolyte membrane. Irradiation of the first border with UV radiation can be carried out before application of the catalyst layer in the process of the invention. However, irradiation can also be carried out after application of the second or third border, so that a plurality of borders comprising UV-curable material are cured simultaneously by irradiation with the UV radiation.

For the purposes of the present invention, it is possible to use UV-curable materials known to those skilled in the art. For example, it is possible to use UV-curable materials as are described in DE 10103428 A1, EP 0463525 B1, WO 2001/55276 A1, WO 2003/010231 A1, WO 2004/081133 A1, WO 2004/083302 or WO 2004/058834 A1.

An example of a liquid, UV-curable pressure sensitive adhesive which can be used is composed of the following: 60-95% of acrylate monomers or acrylated oligomers, 0-30% of adhesion improvers (e.g. resins) and 1-10% of photoinitiators. On irradiation with UV radiation, free radicals are formed from the photoinitiators and curing is then effected by transfer of the free radicals to the monomers or oligomers. Suitable photoinitiators generally comprise a benzoyl group and are obtainable in a number of variants.

For the purposes of the present invention, it is also possible to use, for example, a surface coating composition/adhesive of the KIWO AZOCOL Poly-Plus H-WR type (Kissel+Wolf), which is usually used for the coating of screen printing screens and remains flexible after UV crosslinking.

After irradiation of the first border comprising UV-curable material with UV radiation or after drying of the first border comprising UV-curable material (without UV irradiation), a catalyst layer (which represents an anode catalyst layer or a cathode catalyst layer of the membrane-electrode assembly) is applied so as to cover the inner region of the polymer electrolyte membrane and overlap the first border of UV-cured material in the process of the invention.

The application of the catalyst layer can, for example, be effected by application of a catalyst ink which is a solution comprising at least one catalytic component. The catalyst ink, which may, if appropriate, be paste-like, can be applied by methods with which those skilled in the art are familiar, for example by printing, spraying, doctor blade coating or rolling, in the process of the invention. The catalyst layer can subsequently be dried. Suitable drying methods are, for example, hot air drying, infrared drying, microwave drying, plasma processes or combinations of these methods.

The overlap of the catalyst layer with the first border comprising UV-cured material results in the advantage that the polymer electrolyte membrane is reinforced and protected by the border comprising UV-cured material in the transition region between the catalyst layer and the outer region (in which the polymer electrolyte membrane projects beyond the catalyst layer).

According to the invention, a first border comprising a UV-curable material is firstly applied to the polymer electrolyte membrane so that an inner region of the polymer electrolyte membrane remains free of the UV-curable material and the first border is subsequently irradiated, if appropriate, with UV radiation. This is followed by application of a catalyst layer which covers the inner region of the polymer electrolyte membrane and overlaps the first border. Further UV-curable material is subsequently applied to the first border and irradiated, if appropriate, with UV radiation. As a result of the application of a border comprising UV-cured material in a number of layers, the border can be configured variably in terms of shape and thickness. According to the invention, a second border comprising the UV-curable material is applied to the first border, with the second border surrounding the catalyst layer, and a third border comprising the UV-curable material is subsequently applied to the second border, with the third border overlapping the catalyst layer.

The first, second and third borders are irradiated with UV radiation to effect curing. It is possible to use, for example, medium-pressure mercury vapor lamps for this purpose. Irradiation of the first, second and third borders with UV radiation can in each case be carried out after each application of one of the borders or jointly subsequent to application of at least two borders.

The formation of a border comprising UV-cured material which is composed of the first, second and third borders has the advantage that the margin of the catalyst layer which overlaps the first border is enclosed by the three borders and the resulting total border comprising UV-cured material gives the polymer electrolyte membrane particular stability. In this embodiment, the outer margin of a gas diffusion layer applied to the catalyst layer preferably overlaps the third border.

The border prevents tearing of the membrane at the edge of the electrochemically active area. Without the border arranged according to the invention, this problem of membrane damage occurs, particularly in the case of nonfluorinated membranes, when a sealing frame is used. Apart from this reinforcing function, the border performs a sealing function. Furthermore, a border comprising UV-cured material can, if it adheres well to the polymer electrolyte membrane, prevent the membrane from swelling, being deformed or becoming mechanically unstable in the sealing region.

In the present invention, the first border is preferably applied to the polymer electrolyte membrane in such a thickness that essentially no edges are formed, so that the mechanical compressive stress in the edge region of the electrochemically active area is reduced. The thickness of the border formed by the three borders is preferably in the range from 3 to 500 μm, particularly preferably from 5 to 20 μm.

The invention further relates to a fuel cell comprising at least one membrane-electrode assembly comprising an anode catalyst layer, a polymer electrolyte membrane and a cathode catalyst layer, wherein the polymer electrolyte membrane is joined on each side to a border comprising a UV-cured material, with the respective border comprising a first border which is overlapped by the anode catalyst layer or by the cathode catalyst layer, a second border which is arranged on the first border and surrounds the anode catalyst layer or the cathode catalyst layer and a third border which is arranged on the second border and overlaps the anode catalyst layer or the cathode catalyst layer. The fuel cell of the invention is preferably operated using hydrogen or a liquid fuel.

The membrane-electrode assembly of the fuel cell of the invention is preferably produced by the process of the invention.

The membrane-electrode assembly of the present invention preferably comprises one or two gas diffusion layers which are arranged on the anode catalyst layer and/or on the cathode catalyst layer. In a preferred embodiment of the present invention, at least one of the anode or cathode catalyst layers is joined to a gas diffusion layer. The gas diffusion layer can serve as mechanical support for the electrode and ensures good distribution of the respective gas over the catalyst layer and serves to conduct away the electrons. A gas diffusion layer is required, in particular, for fuel cells which are operated using hydrogen on one side and oxygen or air on the other side.

In the present invention, preference is given to the anode catalyst layer being joined to a first gas diffusion layer and the cathode catalyst layer being joined to a second gas diffusion layer so that the first gas diffusion layer and the anode catalyst layer and also the second gas diffusion layer and the cathode catalyst layer are in each case flush at the edges. If, for example, the anode catalyst layer and the cathode catalyst layer have different planar dimensions, the two gas diffusion layers in this embodiment likewise have these different planar dimensions and their edges are flush with the respective catalyst layer on all sides. However, it is also possible for the anode catalyst layer to be joined to a first gas diffusion layer and the cathode catalyst layer to be joined to a second gas diffusion layer so that at least one of the first and second gas diffusion layers have a margin projecting beyond the anode or cathode catalyst layer. The gas diffusion layers (for example carbon fiber nonwoven or carbon fiber paper) are preferably applied to the catalyst layers by laying-on, rolling, hot pressing or other techniques with which those skilled in the art are familiar.

In a preferred embodiment of the present invention, a sealing frame for sealing the membrane-electrode assembly is arranged on the border comprising UV-cured material. The sealing frame is preferably a frame which performs at least one of the following functions:
protection of the polymer electrolyte membrane against mechanical damage,
spacer for, for example, gas distributor plates which are clamped together with the membrane-electrode assembly and
sealing against the polymer electrolyte membrane.

In addition to the sealing frame, a deformable sealing element, for example a sealing element composed of silicone, polyisobutylene, rubber (synthetic or natural), fluoroelastomer or fluorosilicone, can be used for sealing. As deformable sealing element, it is possible to use, for example, an O-ring. The sealing frame can consist of any unfunctionalized gastight polymer or a metal coated with such a polymer. Polymers which can be used are, in particular, polyether sulfone, polyamide, polyimide, polyether ketone, polysulfone, polytetrafluoroethylene (PTFE), polyvinylidene fluoride (PVDF), polyethylene (PE) or polypropylene (PP).

The respective sealing frame preferably covers a predominant proportion of the surface of a border comprising UV-cured material insofar as this projects beyond the catalyst layer. A deformable sealing element can be arranged on each of the sealing frames so that it is located between the sealing frame and a gas distributor plate in a fuel cell and is clamped there.

The sealing function performed by the sealing frame in an embodiment of the present invention can, however, also be performed by the border comprising UV-cured material in the present invention, so that no sealing frame is necessary. In this case, a deformable sealing element, for example a sealing element composed of silicone, polyisobutylene, rubber (synthetic or natural), fluoroelastomer or fluorosilicone, can be used directly on the border comprising UV-cured material to effect sealing. As deformable sealing element, it is possible to use, for example, an O-ring.

In a preferred embodiment of the present invention, the UV-curable material is applied by screen printing, e.g. by means of rotary or flat-bed screen printing processes. Application of the UV-curable material by the screen printing technique has the advantage that the UV-curable material can be applied in one or more thin layers and cured immediately thereafter (for example crosslinked) so that the polymer electrolyte membrane is stabilized. The catalyst layer is also preferably applied by means of screen printing, so that application of the UV-curable material by screen printing has production engineering advantages. Furthermore, the use of the screen printing technique gives a high degree of configurational freedom in respect of the shape of the layers applied thereby. However, the UV-curable material can also be applied by other methods, e.g. by means of flexographic printing.

In a preferred embodiment of the present invention, on both sides of the polymer electrolyte membrane the border comprising UV-cured material surrounds an inner region in which a catalyst layer which overlaps the first border is located in the fuel cell of the invention. The catalyst layer is covered by a gas diffusion layer and a sealing frame is arranged on the border. A gas distributor plate covers the gas diffusion layer and the sealing frame. The gas distributor plate can, for example, be a bipolar plate or an end plate of a fuel cell or a fuel cell stack. The gas distributor plate preferably comprises on at least one of its surfaces channels for gases, known as the “flow field” which distributes gaseous reactants (for example hydrogen and oxygen) over the gas diffusion layer. Furthermore, the gas distributor plate preferably comprises integrated channels for coolant, in particular for a cooling liquid. A bipolar plate serves to provide electrical connections in the fuel cell, to supply and distribute reactants and coolants and to separate the gas spaces. The gas distributor plate can, for example, comprise a material selected from the group consisting of polyphenylene sulfide (PPS), liquid crystal polyester (LCP), polyoxymethylene (POM), polyaryl ether ketone (PAEK), polyamide (PA), polybutylene terephthalate (PBT), polyphenylene oxide (PPO), polypropylene (PP) or polyether sulfone (PES) or another polymer used in industry. The polymer can be filled with electrically conductive particles, in particular graphite or metal particles. However, the gas distributor plate can also be made of graphite, metal or graphite composites.

In a preferred embodiment of the fuel cell of the invention, a deformable sealing element is arranged between the sealing frame and the gas distributor plate. Grooves can be provided in the gas distributor plate and/or the sealing frame to accommodate the deformable sealing element.

In one variant of the fuel cell of the invention, the gas distributor plate comprises channels for conveying gases along the gas diffusion layer, with the channels having a gas inlet region and the border comprising UV-curing material (composed of three borders) covering the polymer electrolyte membrane beside the gas inlet region. “Burning-through” of the polymer electrolyte membrane is frequently observed in the inlet region for the gases in fuel cells known from the prior art. The extension of the region of the polymer electrolyte membrane covered by UV-cured material into the active area next to the gas inlet region protects the membrane area in this critical region, too. A resulting asymmetric shape of the border can be obtained without problems by, for example, screen printing of the UV-curable material onto the polymer electrolyte membrane.

The invention is illustrated below with the aid of the drawing.

In the drawing:

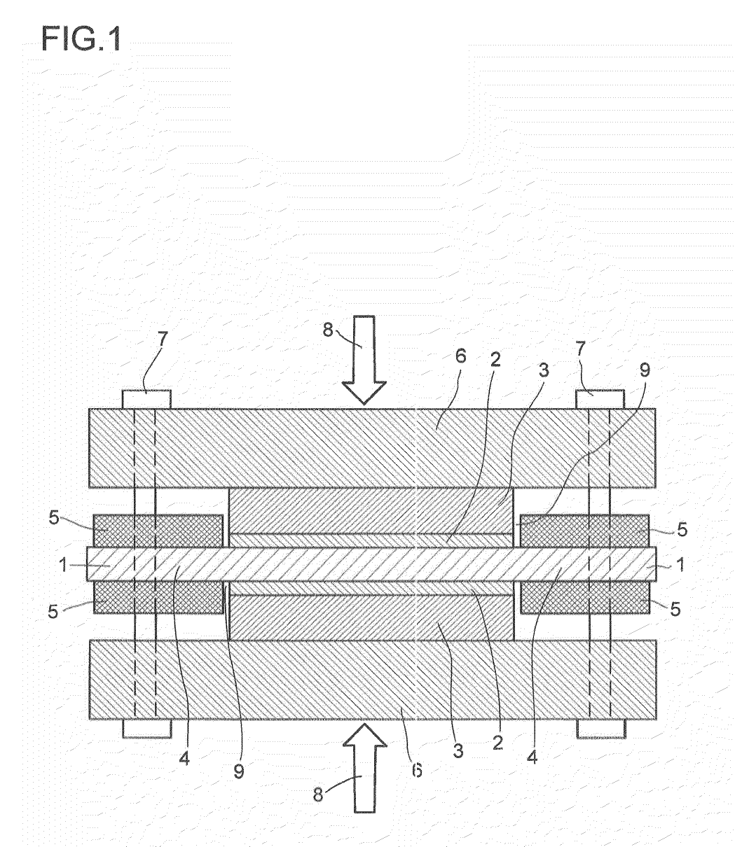

FIG. 1 shows a fuel cell known from the prior art before clamping,

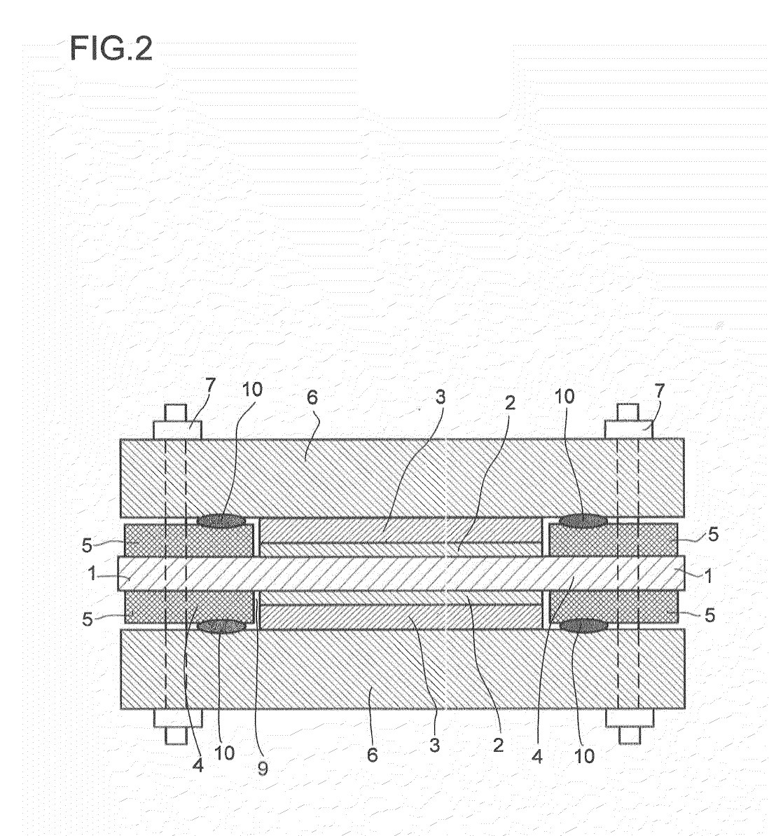

FIG. 2 shows a fuel cell known from the prior art after clamping,

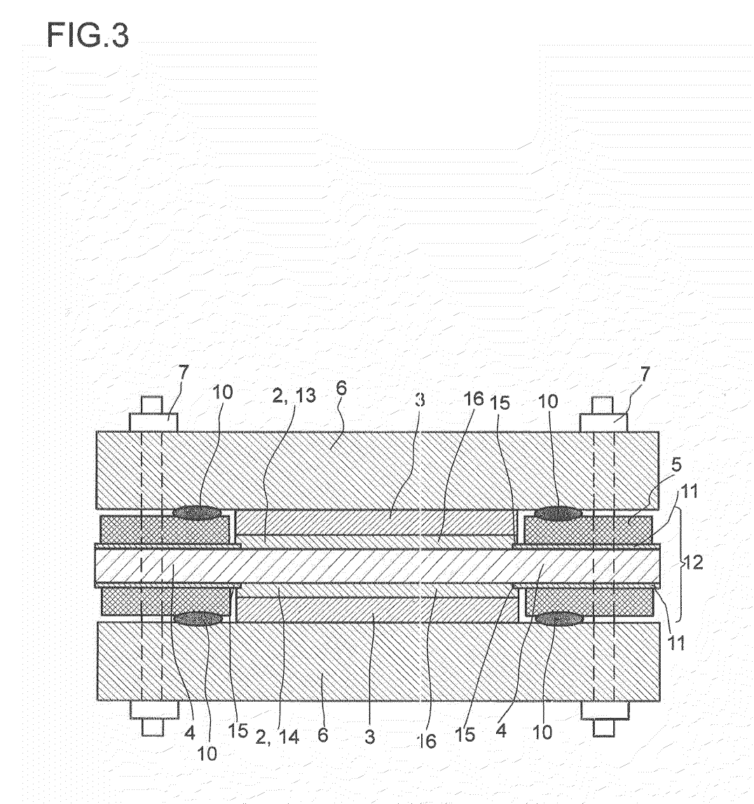

FIG. 3 schematically shows a fuel cell comprising a border comprising UV-cured material,

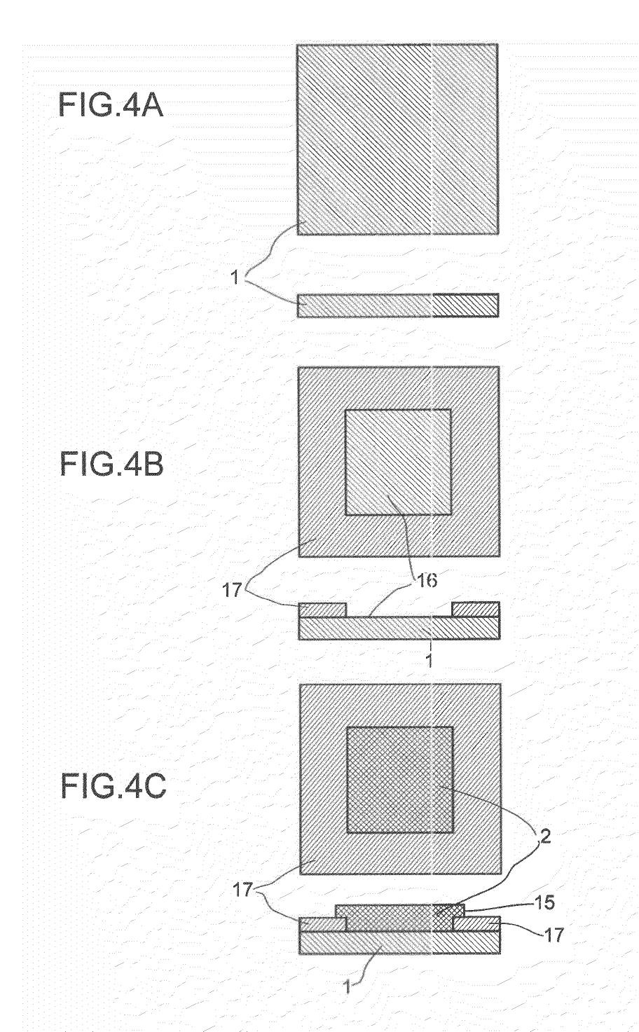

FIGS. 4A to 4C show three steps of the process of the invention for producing a membrane-electrode assembly,

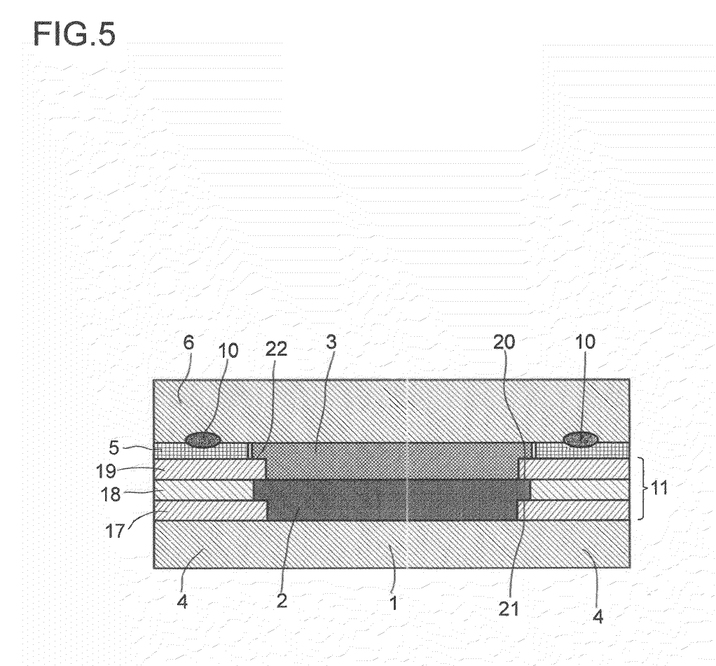

FIG. 5 schematically shows one half of an embodiment of a fuel cell according to the invention and

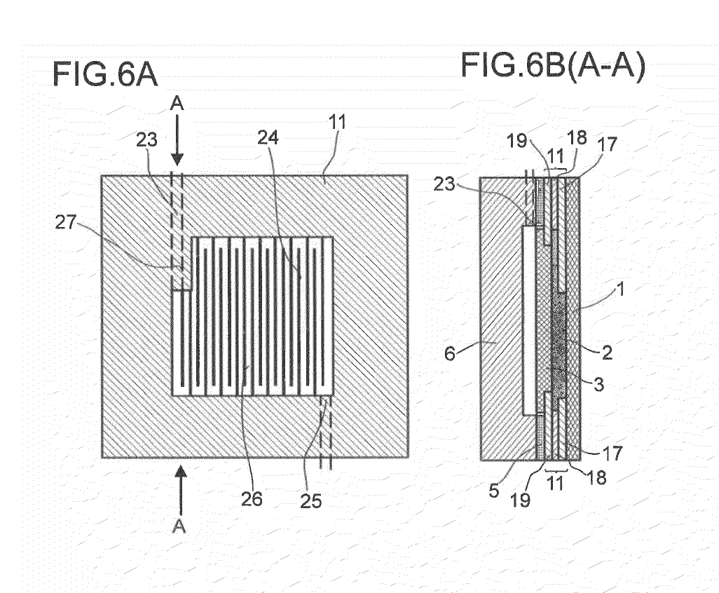

FIGS. 6A and 6B show two views of a further embodiment of a fuel cell according to the invention.

FIG. 1 shows a schematic section through a fuel cell according to the prior art before clamping.

The fuel cell is constructed symmetrically in respect of its individual layers. A catalyst layer 2 which is covered by a gas diffusion layer 3 is arranged on each of both sides of a polymer electrolyte membrane 1. The membrane margin 4 of the polymer electrolyte membrane 1 projects beyond the catalyst layer 2. A sealing frame 5 is arranged on each side of the membrane margin 4. The membrane-electrode assembly comprising the polymer electrolyte membrane 1, the two catalyst layers 2, the two gas diffusion layers 3 and the two sealing frames 5 is enclosed by two gas distributor plates 6 which are joined to one another by clamping screws 7. To clamp the fuel cell, the clamping screws are tightened, resulting in forces acting on the gas distributor plates 6 in the clamping direction 8. As a result, the two gas distributor plates 6 are moved toward one another and the layers located between them are compressed until the gas distributor plates 6 are held against the respective sealing frame 5 and thereby produce a seal against the polymer electrolyte membrane 1. In the critical region 9 between the sealing frames 5 and the associated catalyst and gas diffusion layers 2, 3, there is a risk of tearing of the polymer electrolyte membrane 1, particularly during clamping or as a result of swelling of the membrane 1 during operation.

FIG. 2 shows a schematic section through a fuel cell according to the prior art after clamping.

The fuel cell is constructed essentially like the fuel cell of FIG. 1. The same reference numerals denote the same components of the fuel cell. In addition, this fuel cell comprises deformable sealing elements 10 which are in each case deformed between one of the sealing frames 5 and a gas distributor plate 6 on clamping and ensure a seal against the polymer electrolyte membrane 1. In this embodiment, too, there is a risk of damage to the polymer electrolyte membrane 1 in the critical region 9.

FIG. 3 shows a schematic section through a fuel cell which comprises a border comprising UV-cured material.

In addition to the layers and components known from the prior art (which are denoted by the same reference numerals as in FIGS. 1 and 2), this fuel cell comprises a border 11 comprising UV-cured material. This fuel cell comprises a membrane-electrode assembly 12 comprising an anode catalyst layer 13, a polymer electrolyte membrane 1 and a cathode catalyst layer 14. The polymer electrolyte membrane 1 is joined on both sides to a border 11 comprising a UV-cured material, with the respective border 11 overlapping the anode catalyst layer 13 or the cathode catalyst layer 14 (overlap region 15). On each side of the polymer electrolyte membrane 1, the border 11 comprising UV-cured material surrounds an inner region 16 in which a catalyst layer 2, 13, 14 which overlaps the border 11 and is covered by a gas diffusion layer 3 is located. A sealing frame 5 (for example a frame made of Teflon) is arranged on the border 11 and a gas distributor plate 6 covers the gas diffusion layer 3 and the sealing frame 5. A deformable sealing element 10 (for example an O-ring) is arranged between the sealing frame 5 and the gas distributor plate 6.

FIGS. 4A to 4C schematically show the result of individual steps of the process of the invention for producing a membrane-electrode assembly, in each case in plan view (top) and in section (bottom).

FIG. 4A depicts a polymer electrolyte membrane 1 which, according to one embodiment of the process of the invention, serves as starting layer for producing a membrane-electrode assembly.

FIG. 4B shows a first border 17 comprising a UV-curable material which has been applied to the polymer electrolyte membrane, with the inner region 16 of the polymer electrolyte membrane 1 being free of UV-curable material. The border 17 is irradiated with UV radiation so that the UV-curable material cures.

FIG. 4C shows a catalyst layer 2 which has been applied so as to cover the inner region 16 of the polymer electrolyte membrane 1 and overlaps the border 17 in the overlap region 15.

FIG. 5 shows a schematic section through an embodiment of a fuel cell of the invention, of which only half is depicted. In the finished fuel cell, which has a symmetric construction, the sequence of layers depicted above the polymer electrolyte membrane 1 is repeated on the underside in the reverse order.

The fuel cell according to the invention shown in FIG. 5 has a polymer electrolyte membrane 1, a catalyst layer 2, a gas diffusion layer 3, a sealing frame 5, a gas distributor plate 6 and a deformable sealing element 10 let into grooves comprised in the gas distributor plate 6. A first UV-cured border 17 is joined to the polymer electrolyte membrane. The catalyst layer 2 overlaps this first border 17 in the first overlap region 21. A second border 18 of the UV-cured material has been applied to the first border and surrounds the catalyst layer 2. A third border 19 comprising UV-cured material has been applied to the second border 18, with the third border overlapping the catalyst layer 2 (second overlap region 20). The gas diffusion layer 3 in turn overlaps the third border 19 in the third overlap region 22. This sequence of layers gives particularly good stabilization of the polymer electrolyte membrane 1 in the critical region.

FIG. 6A schematically shows a further embodiment of a fuel cell according to the invention.

This figure shows a fuel cell having a border 11 comprising UV-cured material which covers the polymer electrolyte membrane (not shown) even next to a gas inlet region 23 of a gas distributor plate 6. The channels 24 of the gas distributor plate 6 which serve to convey gases (reactants) along the gas diffusion layer (not shown) are depicted. A gas enters these channels 24 through the gas inlet region 23 and exits again via the gas outlet region 25. For the border 11 to cover the polymer electrolyte membrane even beside the gas inlet region 23, it is extended into the electrochemically active inner region 26 by the extension 27 which stabilizes this region.

FIG. 6B shows such a construction of a fuel cell according to the invention in section (only one half).

The gas distributor plate 6 with the gas inlet region 23 and the channels 24 covers a membrane-electrode assembly having a gas diffusion layer 3, sealing frames 5, catalyst layer 2, border 11 comprising UV-cured material and polymer electrolyte membrane 1. The border 11 is extended so that it covers and protects the polymer electrolyte membrane 1 next to the gas inlet region 23. The border 11 comprises a first border 17, a second border 18 and a third border 19 comprising UV-cured material which surround the catalyst layer 2 around its outer edge.

### LIST OF REFERENCE NUMERALS

1 Polymer electrolyte membrane
2 Catalyst layer
3 Gas diffusion layer
4 Membrane margin
5 Sealing frame
6 Gas distributor plate
7 Clamping screw
8 Clamping direction
9 Critical region
10 Deformable sealing element
11 Border
12 Membrane-electrode assembly
13 Anode catalyst layer
14 Cathode catalyst layer
15 Overlap region
16 Inner region
17 First border
18 Second border
19 Third border
20 Second overlap region
21 First overlap region
22 Third overlap region
23 Gas inlet region
24 Channels
25 Gas outlet region
26 Electrochemically active region
27 Extension

1. A process for producing a membrane-electrode assembly comprising an anode catalyst layer, a polymer electrolyte membrane and a cathode catalyst layer, which comprises applying a first border comprising a UV-curable material to the polymer electrolyte membrane, with an inner region of the polymer electrolyte membrane remaining free of the UV-curable material, applying a catalyst layer which covers the inner region of the polymer electrolyte membrane and overlaps the first border, applying a second border comprising the UV-curable material to the first border, with the second border surrounding the catalyst layer, applying a third border comprising the UV-curable material to the second border, with the third border overlapping the catalyst layer, and irradiating the first, second and third borders with UV radiation.

2. The process according to claim 1, wherein a first border comprising UV-curable material is applied to each of both sides of the polymer electrolyte membrane and irradiated with UV radiation and a catalyst layer which overlaps the first border in each case is applied to both sides.

3. The process according to either claim 1, wherein a sealing frame for sealing the membrane-electrode assembly is arranged on the third border.

4. The process according to claim 1, wherein the UV-curable material is applied by screen printing.

5. The process according to claim 1, wherein the catalyst layer is applied by screen printing.

6. A fuel cell comprising at least one membrane-electrode assembly comprising an anode catalyst layer, a polymer electrolyte membrane and a cathode catalyst layer, wherein the polymer electrolyte membrane is joined on each side to a border comprising a UV-cured material, with the respective border comprising a first border which is overlapped by the anode catalyst layer or by the cathode catalyst layer, a second border which is arranged on the first border and surrounds the anode catalyst layer or the cathode catalyst layer and a third border which is arranged on the second border and overlaps the anode catalyst layer or the cathode catalyst layer.

7. The fuel cell according to claim 6, wherein a sealing frame is arranged on the third border.

8. The fuel cell according to claim 6, wherein a gas diffusion layer in each case covers the anode catalyst layer and the cathode catalyst layer.

9. The fuel cell according to claim 8, wherein the gas diffusion layer overlaps the third border on each side of the polymer electrolyte membrane.

10. The fuel cell according to claim 8, wherein a gas distributor plate covers the gas diffusion layer.

11. The fuel cell according to claim 8, wherein a sealing frame is arranged on the third border and a gas distributor plate covers the gas diffusion layer and the sealing frame and a deformable sealing element is arranged between the sealing frame and the gas distributor plate.

12. The fuel cell according to claim 10, wherein the gas distributor plate comprises channels for conveying gases along the gas diffusion layer, with the channels having a gas inlet region and the border comprising UV-curing material covering the polymer electrolyte membrane beside the gas inlet region.

13. The fuel cell according to claim 11, wherein the gas distributor plate comprises channels for conveying gases along the gas diffusion layer, with the channels having a gas inlet region and the border comprising UV-curing material covering the polymer electrolyte membrane beside the gas inlet region.
